(19) United States
(12) Patent Application Publication
(10) Pub. No.: US 2018/0330700 A1
(43) Pub. Date: Nov. 15, 2018

(54) SEAT COMPRISING A DRUM ELEMENT

(71) Applicant: PATRICE BARDIN, GRILLON (FR)

(72) Inventor: PATRICE BARDIN, GRILLON (FR)

(21) Appl. No.: 15/537,416

(22) PCT Filed: Sep. 25, 2014
(86) PCT No.: PCT/FR2014/052412

§ 371 Date: Jun. 18, 2017

(51) Int. Cl. G10D 13/02; A47C 9/08

(52) U.S. Cl. CPC G10D 13/026; A47C 9/08

(57) ABSTRACT

The seat comprises a main drum element comprising a main shell (21) closed at one end by a batter head (22). The main shell is secured to at least one leg (12) that ends at the base of same with a foot (13), and ends at the top of same with a seat part (11). The seat further comprises an offset main pedal (31) actuating a main percussion means (33) facing the batter head.
The main shell is traversed, through two holes (23), by a leg (12).
In certain embodiments, the seat comprises removable means for fastening the main shell to at least one leg.
In certain embodiments, the seat further comprises an offset secondary pedal actuating a secondary percussion means.

### TECHNICAL FIELD OF THE INVENTION

The invention relates to a seat comprising a drum element. It is specifically designed for professional and amateur musicians who want to be able to easily transport their musical instruments and to make them easier to use, especially for street performances, concerts and teaching. The invention is intended for all musicians who want a rhythmic accompaniment (singers, flautists, guitarists, bass players, etc).

### STATE OF THE ART

The drum kit is a set of drums, cymbals and other percussion instruments used in most current musical genres to mark the beat. The musician has a seat that allows him to interact with all the instruments surrounding him. With the bass guitar, double bass or percussion instruments, the drum is part of the rhythm section of an orchestra or music group.

Like the snare drum, the bass drum is one of the main elements of the drum kit, generally comprising a cylindrical shell, two drumheads (batter head and resonance head) and its fittings. The large-sized bass drum is traditionally placed directly on the floor, in front of the musician. The bass drum is most frequently played with the foot, with a pedal actuating a mallet.

The seats currently used for playing the drum kit have the major disadvantage for musicians of being an additional element to be transported, as well as the instruments. Another significant disadvantage lies in the fact that, when the musician is sitting on the seat and uses a bass drum, it is positioned in front of him and forms a visual obstacle between the musician and his public. In addition, during use, frequently the bass drum gradually moves as a result of repeated mallet strikes.

Documents U.S. Pat. No. 1,774,744, U.S. Pat. No. 5,744,738, JP S52 133620 and U.S. Pat. No. 4,091,706 are known, which describe bulky percussion equipment, unsuitable for the smallest venues, that do not make easy transport possible.

### SUBJECT OF THE INVENTION

The present invention aims to remedy all or part of these drawbacks.

To this end, the present invention envisages a seat, which comprises a main drum element comprising a main shell closed at one end by a batter head, the main shell being secured to at least one leg that ends at the base of same with a foot and ends at the top of same with a seat part, the seat also comprising an offset main pedal actuating a main percussion means facing the batter head, wherein the main shell is traversed, through two holes, by a leg.

Thanks to these provisions, an assembly is obtained that allows the musician to keep the main drum shell in place by sitting on it. The main advantage is the space savings compared to a standard drum kit, and the simplicity of transport this type of seat offers. In addition, during street performances, concerts and other performances, it makes it possible not to have a visual obstacle between the musician and his public or, during a lesson, between the teacher and his student. Another advantage is that the musician immobilizes the main shell with the seat. The main shell is therefore unlikely to move under the effect of strikes hitting the batter head. Guitarists who use the seat that is the subject of the invention can place their effects pedals in any position in front of the seat, which is not possible with a conventional bass drum. The term “drumhead” refers to the substantially flat panel closing one or both holes of the main shell, traditionally produced by a stretched skin. The batter head is the one that receives the percussion.

Because the main shell is traversed, through two holes, by at least one leg, the seat part extends over the main shell, which reduces the dimensions, in terms of floor space, and makes transport easier.

In some embodiments, the main percussion means is secured to one panel of the main shell.

In some embodiments, the main percussion means is secured to the foot of the seat.

Thanks to each of these provisions, the main percussion means can, at any time, be changed or adjusted to strike the center or edge of the batter head. In addition, it is held in position facing the drumhead, thereby avoiding a change in the sound produced.

In some embodiments, the seat that is the subject of the present invention comprises an offset secondary pedal actuating a secondary percussion means.

Thanks to these provisions, the musician actuates a secondary percussion means, which can advantageously strike the batter head of the main drum element, or actuate a different instrument.

In some embodiments, the seat that is the subject of the present invention comprises a secondary drum element consisting of a secondary shell closed at one end by a batter head, the secondary pedal actuating the secondary percussion means, which strikes the batter head of the secondary drum element.

Thanks to these provisions, the musician can play on two drums of the same size, or of different sizes, by actuating the two pedals available to him.

In some embodiments, the secondary percussion means is a cymbal, known as a “high hat” or “hi-hat”, secured to the seat.

Thanks to these provisions, the musician can actuate a so-called hi-hat cymbal thanks to the secondary pedal. The hi-hat cymbal is advantageously secured to the foot of the seat or to at least one leg.

In some embodiments, the secondary pedal actuates the secondary percussion means, which strikes the batter head of the main drum element.

Thanks to these provisions, the musician can increase the rhythm of strikes on the drumhead of the main shell and, because the two percussion means are not positioned facing the same portion of the drumhead, obtain different sounds according to the percussion means used.

In some embodiments, the offset main pedal actuates the main percussion means remotely by a moving cable system in a sleeve.

Thanks to these provisions, simply pressing the main pedal makes it possible to move the cable inside the sleeve and remotely actuates the main percussion means. The main pedal can therefore be freely positioned by the musician, with the moving cable system in a sleeve transferring the movement of the foot to the main percussion means, regardless of the position of the main pedal.

In some embodiments, the seat comprises, for each hole of the main shell surrounding the leg, a hermetic seal closing the hole.

Thanks to these provisions, the vibrations of the main shell are not transmitted to the seat. In addition, properly sealing the panel of the main shell gives it better sound properties.

In some embodiments, the length of at least one leg is adjustable.

Thanks to these provisions, the musician can, depending on his size and desired level of comfort, adjust the seat surface to the height that suits him best. Another advantage lies in the transport of the seat, during which the height of at least one leg can be reduced, to save space.

In some embodiments, the seat that is the subject of the present invention comprises a lighting means in at least one shell, at least one portion of each shell comprising a lighting means being transparent or translucent.

Thanks to these provisions, during a concert or a street performance, the musician can combine light effects with the sounds produced by the instruments.

In some embodiments, the seat that is the subject of the present invention also comprises a remote control making it possible to actuate the lighting means.

Thanks to these provisions, the musician, or an operator in charge of visual effects, can remotely trigger the desired visual effects.

In some embodiments, the transparent or translucent portion comprises an opaque portion.

Thanks to these provisions, when lighting effects are utilized, light does not pass through the opaque portion, and the transparent or translucent portion reveals a visual, which can be an image, a text such as the name of the music group, or a set of visual elements.

In some embodiments, the seat that is the subject of the present invention comprises at least one fastening means configured to hold the main pedal maintained against the main drum element while the seat is transported.

Thanks to these provisions, during transport, the main pedal is held against the main drum element and consequently presents no risk of hitting or damaging the main drum element, especially the batter head, or of accidentally striking persons or objects outside the seat that is the subject of the present invention.

According to particular features, the seat that is the subject of the present invention comprises a means for fastening removable wheels.

Thanks to these provisions, the user can easily move the seat by rolling it.

### BRIEF DESCRIPTION OF THE FIGURES

Other advantages, aims and characteristics of the present invention will become apparent from the description that will follow, made as an example that is in no way limiting, with reference to the drawings included in an appendix, in which:

FIG. 1 represents, schematically and in a partial perspective view, a first particular embodiment of the seat that is the subject of the present invention, with a main shell and a main pedal;

FIG. 2 represents a second particular embodiment of the seat that is the subject of the present invention, with two pedals and two shells;

FIG. 3 represents a third particular embodiment of the seat that is the subject of the present invention, with two pedals, a main shell, cymbals and a lighting means; and

FIG. 4 represents, in a partial cross-section view, a main drum element of each embodiment of the seat that is the subject of the present invention.

25

### DESCRIPTION OF EXAMPLES OF REALIZATION OF THE INVENTION

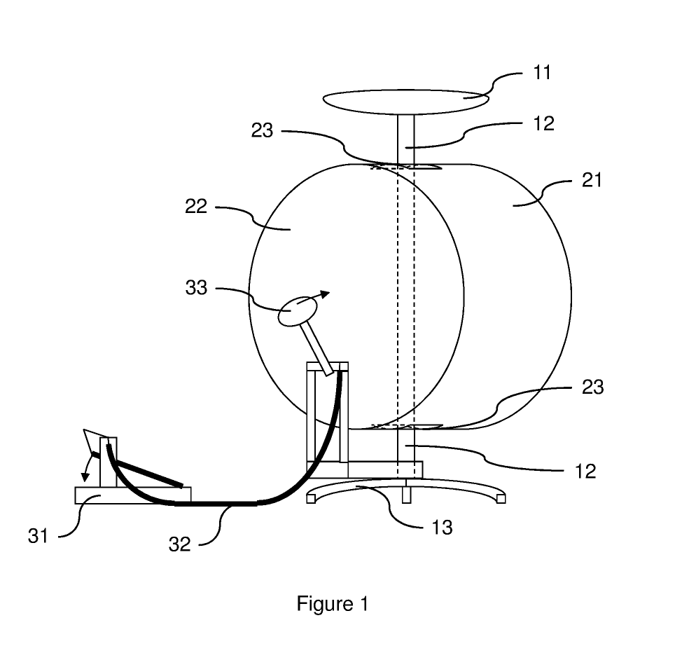

It is now noted that FIGS. 1-4 are not to scale.

The seat that is the subject of the present invention comprises a main drum element comprising a main shell 21 closed at one end by a batter head 22. The main shell 21 is secured to at least one leg 12 that ends at the base of same with a foot 13, and ends at the top of same with a seat part 11. The seat also comprises an offset main pedal 31 actuating a main percussion means 33 facing the batter head 22.

The main shell 21 is traversed, through two holes 23, by a leg 12. Preferably, the leg 12 of the seat traverses the main shell 21 at a distance from the batter head 22 of between five and twenty centimeters, and more preferably between ten and fifteen centimeters.

Therefore, the seat surface 11 is positioned such that the main percussion means 33 is not hampered, in its movement, by the legs of the user, and vice versa.

Preferably, the foot 13 of the seat consists of a tripod so it can remain stable on uneven ground, especially for street performances where the ground may be irregular, eg cobblestones.

Therefore, the seat surface 11 of the seat is preferably of small dimensions, such as a simple padded disk. However, the seat surface 11 can also have a back.

Preferably, the leg 12 of the seat is adjustable in length. In this case, the adjustment of the leg 12 advantageously has a locking means defining a maximum lowering that is greater than the diameter of the main shell 21.

Preferably, the length of the leg 12 is adjusted by a system chosen from an actuator and a screw foot.

Advantageously, the seat surface 11 of the seat is mounted in a freely rotatable way on the leg 12 such as a bar stool type of seat surface (not shown).

Preferably, the main shell 21 is cylindrical and is closed at one end by a batter head 22, and at another end by a resonance panel. The acoustics of the main shell 21 are thus improved. Traditionally, the main shell 21 is also reinforced by fittings (not shown).

Preferably, the main shell 21 used here is a snare drum, bass drum or “16-inch Tom”, so-called because of its 16-inch diameter. However, the seat can also comprise several shells of different sizes (16, 18, 20, or 22 inches) or possibly a cajon (not shown).

Advantageously, the leg 12 of the seat consists of a tube, preferably made of metal, which vertically traverses the main shell 21 through its diameter. Advantageously, the seat comprises a seal 24 placed at one at least of the interfaces between the main shell 21 and the leg 12.

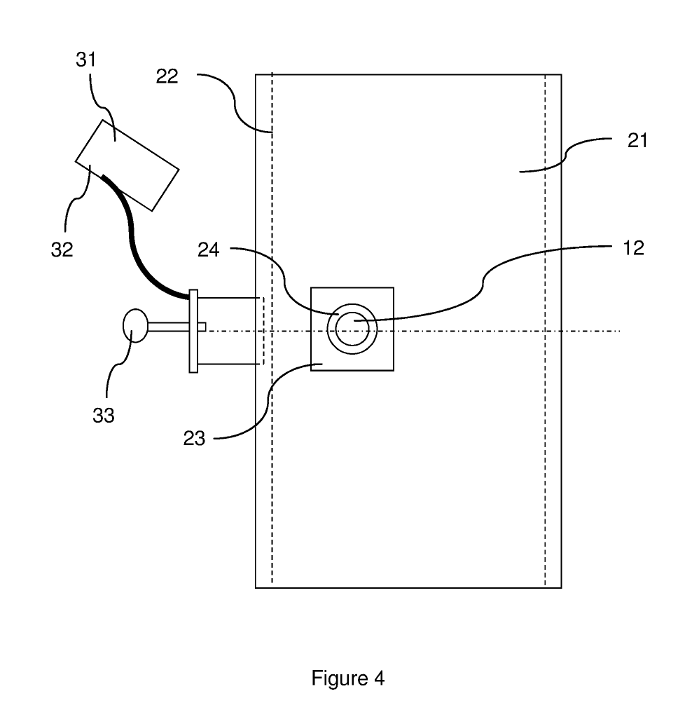

As shown in FIG. 4, the leg 12 traverses the main shell 21 through two holes 23, the seat comprising a seal 24 at one at least, preferably both, of the two holes 23 between the panel of the main shell 21 and at least one leg 12. The vibrations of the main shell 21 are therefore reduced and the acoustics of the main shell 21 are improved. This seal 24 is, for example, made of elastic material (such as rubber) or foam.

The main percussion means 33 is advantageously chosen from a drumstick, brush, whip and mallet, or any other instrument designed to strike the batter head 22 of the main shell 21 to produce a sound effect.

Preferably, the main percussion means 33 is secured to the panel of the main shell 21, to the leg 12 or to the foot 13 of the seat. The strike height is therefore adjusted by the user depending on the desired sound effect.

Advantageously, the main percussion means 33 is secured by a quick fastening means so the main percussion means 33 can be replaced easily.

In an advantageous way, the offset main pedal 31 rests on the ground by the intermediary of an adhesion plate, for example made of flexible plastic material.

Advantageously, the main pedal 31 can be used equally well with the left foot as the right foot. By being offset at the end of a cable 32 and a flexible sleeve, it can be easily moved according to the comfort and habit of the user.

Preferably, the main pedal 31 has a high position (at rest) and a low position when the user presses the foot down. The main pedal 31 is kept in a high position by a spring. Changing the position of the main pedal 31 results in a cable 32 moving inside a sleeve connecting the main pedal 31 to the main percussion means 33.

The main percussion means 33 also has two positions, one rest position in which the main percussion means 33 is distant from the batter head 22 of the main shell 21, and a strike position in which the main percussion means strikes the batter head 22. The main percussion means 33 is advantageously kept in the rest position by a spring.

When the user exerts pressure greater than the force of the spring on the main pedal 31, the main pedal changes position, which results in the cable 32 moving in the sleeve and exerting a force against the spring of the main percussion means 33, and results in changing the position of the main percussion means 33, which strikes the batter head 22.

Once the user releases the main pedal 31, the latter resumes its high position as a result of the spring, and the same applies to the main percussion means 33, the cable 32 in the sleeve resuming its initial position.

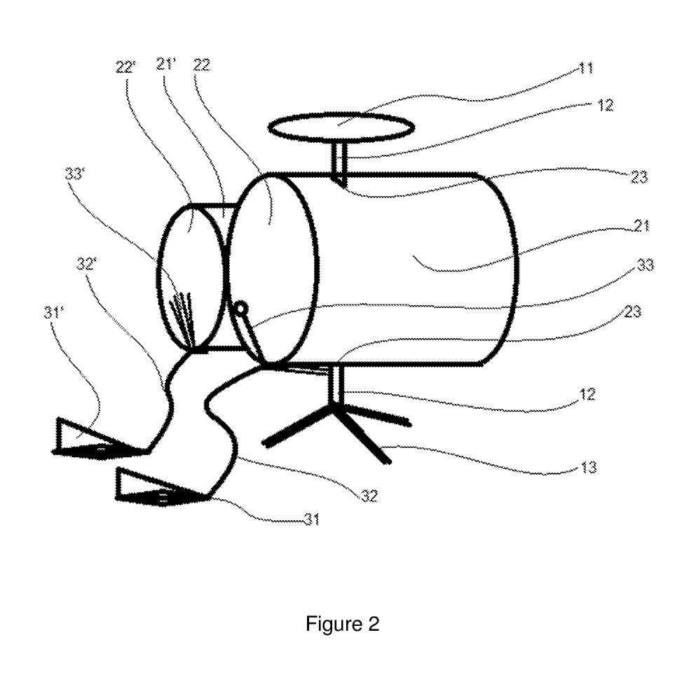

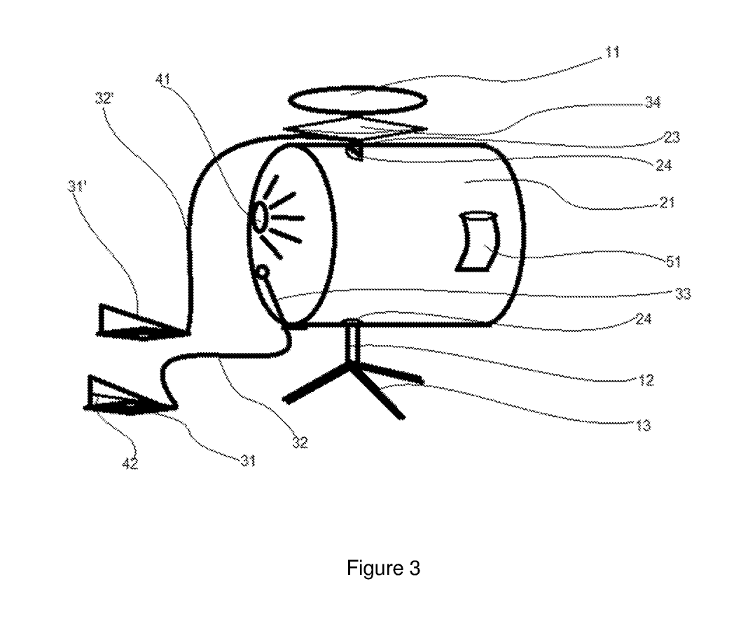

Advantageously, as shown in FIGS. 2 and 3, the seat has an offset secondary pedal 31′ actuating a secondary percussion means 33′.

In the embodiment shown in FIG. 2, the seat comprises a secondary drum element consisting of a secondary shell 21′ closed at one end by a batter head 22′. The secondary pedal 31′ actuates a secondary percussion means 33′ striking the batter head 22′ of the secondary drum element. This secondary shell 21′ is advantageously secured to the side, attached to the main shell 21, or positioned above or below the main shell 21. The secondary shell can also be attached to the foot 13 or leg 12 of the seat. The secondary percussion means 33′ is secured so as to be able to strike the batter head 22′ of the secondary shell 21′.

Alternatively, in the embodiment shown in FIG. 3, a cymbal 34 known as a “high hat” or “hi-hat” is secured to the foot 13 or to at least one leg 12 of the seat and is actuated by the secondary pedal 31′.

A hi-hat cymbal 34 consists of a pair of cymbals advantageously attached to at least one leg 12 of the seat, above or below the main shell 21. Preferably, the leg 12 of the seat traverses each of the cymbals, as shown in FIG. 3.

By pressing on the secondary pedal 31′, the musician closes the top cymbal, serving as secondary percussion means, on the bottom one, forming a secondary drum element, and in this way establishing contact between the two cymbals 34. The upper cymbal can be secured higher or lower on the leg 12, increasing or reducing the articulation between the two cymbals to suit the user's taste.

As shown in FIG. 3, the seat advantageously comprises, in at least one shell (the single shell 21, in FIG. 3), a lighting means 41. At least one portion of each shell comprising a lighting means, for example the panels, batter head 22, and/or the resonance panel, is transparent or translucent.

In some embodiments, the transparent or translucent portion comprises an opaque portion representing a message. In this way, when lighting effects are utilized, light does not pass through the opaque portion, and the transparent or translucent portion reveals a visual, which can be an image, a text such as the name of the music group, or a set of visual elements.

The seat also comprises a remote control 42 making it possible to modulate the lighting means 41.

Advantageously, the remote control 42 is actuated by the play of the main pedal 31, and in this way the light effects will be associated to the sounds produced. In this particular case, it is the rhythm imposed on the main pedal 31 by the user that determines the modulation, in intensity and/or in colors for example, of the lighting means 41.

This modulation can therefore consist of a variation in light intensity or a color variation issued by the lighting means 41, to the beat of the drum kit.

The seat preferably has at least one fastening means 51, which holds an offset main pedal 31 maintained against the main drum element while the seat is transported. This fastening means 51 is advantageously chosen from (but not exclusively): a self-adhesive strip, a push button, an elastic band.

The main drum element advantageously has a guitar stand (not shown). In this way, a guitarist can place his guitar on it to stabilize it.

The seat preferably comprises a built-in stand (not shown). The musician therefore has a support, specifically for holding the scores for a piece of music.

### EXAMPLE 1

### A Single Main Shell FIG. 1

The seat comprises a main drum element comprising a main shell 21 closed at one end by a batter head 22, the main shell 21 being secured to one leg 12 that ends at the base of same with a foot 13, and ends at the top of same with a seat part 11, the seat also comprising an offset main pedal 31 actuating a main percussion means 33 facing the batter head 22.

The main shell 21 is traversed, through two holes 23, by the leg 12.

The main percussion means is a drumstick.

The main percussion means is secured to the edge of the main shell 21.

### EXAMPLE 2

### Two Pedals and Two Shells FIG. 2

The seat comprises a main drum element comprising a main shell 21 closed at one end by a batter head 22, the main shell 21 being secured to one leg 12 that ends at the base of same with a foot 13, and ends at the top of same with a seat part 11, the seat also comprising an offset main pedal 31 actuating a main percussion means 33 facing the batter head 22.

The main shell 21 is traversed, through two holes 23, by the leg 12.

The main percussion means 33 is a mallet.

The main percussion means 33 is secured to the foot of the seat.

The seat also comprises an offset secondary pedal 31′ actuating a secondary percussion means 33′.

The seat comprises a secondary drum element consisting of a secondary shell 21′ closed at one end by a secondary batter head 22′, and the secondary percussion means 33′ strikes the secondary batter head 22′ of the secondary drum element.

The secondary percussion means 33 is a whip.

The secondary percussion means 33′ is secured to the edge of the secondary shell 21′.

The main 31 and secondary 31′ offset pedals remotely actuate the main 33 and secondary 33′ percussion means, respectively, by a system of cables 32, 32′, each being movable in a sleeve.

### EXAMPLE 3

### Two Pedals, One Shell and One Cymbal FIG. 3

The seat comprises a main drum element comprising a main shell 21 closed at one end by a batter head 22, the main shell 21 being secured to one leg 12 that ends at the base of same with a foot 13, and ends at the top of same with a seat part 11, the seat also comprising an offset main pedal 31 actuating a main percussion means 33 facing the batter head 22.

The main shell 21 is traversed, through two holes 23, by the leg 12.

The main percussion means 33 is a mallet.

The main percussion means 33 is secured to the edge of the main shell 21.

The seat also comprises an offset secondary pedal 31′ actuating a secondary percussion means 34.

The secondary percussion means 34 is a cymbal, known as a “high hat” or “hi-hat”, secured to the seat.

The offset pedals remotely actuate the percussion means 33 and 34 by a system of cables 32, 32′, each being movable in a sleeve.

The seat comprises a seal 24 made of elastic material, for example made of natural or synthetic rubber, placed at each of the two holes 23 between the panel of the shell 21 and the leg 12 of the seat. The seal 24 plugs the hole 23.

The leg 12 is adjustable in length.

The seat comprises a lighting means 41 placed inside the shell 21, the batter head 22 and the resonance panel being transparent or translucent. More generally, all or part of the panels of the shell 21 is transparent or translucent.

The seat also comprises a remote control 42 making it possible to modulate the lighting means 41. This modulation is actuated by the offset main pedal 31.

The seat has at least one fastening means 51, which holds an offset main pedal 31 maintained against the main shell of the main drum element while the seat is transported.

The fastening means 51 is a self-adhesive strip.

1-16. (canceled)

17. Seat, comprising a main drum element comprising a main shell closed at one end by a batter head, the main shell being secured to at least one leg that ends at the base of same with a foot, and ends at the top of same with a seat part, the seat also comprising an offset main pedal actuating a main percussion means facing the batter head, wherein the main shell is traversed, through two holes, by a leg.

18. Seat, according to claim 17, wherein the main percussion means is secured to one panel of the main shell.

19. Seat, according to claim 17, wherein the main percussion means is secured to the foot.

20. Seat, according to claim 17, wherein the main percussion means is secured to the leg.

21. Seat according to claim 1, which comprises an offset secondary pedal actuating a secondary percussion means.

22. Seat according to claim 21, which comprises a secondary drum element consisting of a secondary shell closed at one end by a batter head, the secondary pedal actuating the secondary percussion means, which strikes the batter head of the secondary drum element.

23. Seat according to claim 22, wherein the secondary percussion means is a cymbal, known as a “high hat” or “hi-hat”, secured to the seat.

24. Seat according to claim 21, wherein the secondary pedal actuates the secondary percussion means, which strikes the batter head of the main drum element.

25. Seat according to claim 1, wherein the offset main pedal actuates the main percussion means remotely by a moving cable system in a sleeve.

26. Seat according to claim 1, which comprises, for each hole of the main shell surrounding the leg, a hermetic seal closing the hole.

27. Seat according to claim 1, wherein the length of at least one leg is adjustable.

28. Seat according to claim 1, which comprises a lighting means in at least one shell, at least one portion of each shell comprising a lighting means being transparent or translucent.

29. Seat according to claim 28, which also comprises a remote control making it possible to actuate the lighting means.

30. Seat according to claim 28, wherein the transparent or translucent portion of the shell comprises an opaque portion.

31. Seat according to claim 1, which comprises at least one fastening means, which holds the main pedal maintained against the main drum element while the seat is transported.

32. Seat according to claim 1, which comprises a means for fastening removable wheels.
